(19) United States
(12) Patent Application Publication
(10) Pub. No.: US 2017/0038100 A1
(43) Pub. Date: Feb. 9, 2017

(54) METHOD AND APPARATUS FOR THERMALLY DISCONNECTING A CRYOGENIC VESSEL FROM A REFRIGERATOR

(71) Applicant: SIEMENS HEAL THCARE LIMITED, Camberley (GB)

(72) Inventor: Mary Ellen Quigley, Eynsham (GB)

(73) Assignee: SIEMENS HEAL THCARE LIMITED, Camberley (GB)

(21) Appl. No.: 15/304,174

(22) PCT Filed: Mar. 10, 2015
(86) PCT No.: PCT/EP2015/054945

§ 371 Date: Oct. 14, 2016

(30) Foreign Application Priority Data
Apr. 16, 2014 (GB) 1406836.5

(51) Int. Cl. F25B 9/10; F17C 3/08; F25D 19/00

(52) U.S. Cl. CPC F25B 9/10; F25D 19/006; F17C 3/085; F25B 2400/17; F17C 2221/017; F17C 2227/0337; F17C 2203/0308; F17C 2203/0391; F17C 2223/0161; F17C 2205/0323; F17C 2270/01

(57) ABSTRACT

The present invention relates to a method of thermally disconnecting a cryogenic vessel (2) of a cryostat (1) from a refrigerator (7), e.g. during transportation of the cryostat (1). In order to provide a simple and reliable technique for thermally disconnecting the refrigerator (7) from the cryogenic vessel (2), the cryogenic vessel (2) is connected with the refrigerator (7) by means of an input channel (17) and an output channel (18), wherein the input channel (17) and the output channel (18) are adapted to provide a loop system for a convection circulation of cryogen through the refrigerator (7).

### BACKGROUND OF THE INVENTION

Field of the Invention

The present invention relates to a method of thermally disconnecting a cryogenic vessel of a cryostat from a refrigerator, e.g. during transportation of the cryostat. Furthermore, the present invention relates to a cryostat.

Description of the Prior Art

In an MRI (magnetic resonance imaging) system, a cryostat may be employed, said cryostat comprising a cryogenic vessel holding a liquid cryogen, e.g. liquid helium, for cooling the superconducting magnet coils. A refrigerator provides active refrigeration to cool the cryogen within the cryogenic vessel.

However, in case of transportation of the superconducting magnet system, e.g. from the manufacturing site to the operational site, the refrigerator is inactive, and is incapable of diverting the heat load from the cryogen vessel. Instead, the refrigerator itself provides a thermal path for ambient heat to reach the cryogenic vessel, and transportation heat loads are much greater than those of normal operation when the refrigerator is running.

If the refrigerator is switched off and not vented, a heat load of typically 5W is delivered into the cryogenic vessel by thermal conduction through the refrigerator, leading to an evaporation of cryogen of about 10% per day, and warming up the magnet coils to a quench-risk level. As it can be seen, such heat input during transportation significantly increases cryogen losses, and thus considerably reduces the time-to-dry and time-to-refill, which both are critical magnet parameters determining the maximum possible duration of transportation of the cryostat.

In the past, removing the refrigerator for transportation has been considered. However, this has turned out to be not practical, as it creates a risk of ice ingress, logistic problems and extra workload for installation engineers.

Furthermore, it has been suggested to thermally detach the refrigerator from the cryogenic vessel by removing the cryogen from the refrigerator. However, this approach is expensive, unreliable, and thermally inefficient.

### SUMMARY OF THE INVENTION

It is therefore an object of the present invention to provide a simple and reliable technique for thermally disconnecting a refrigerator from a cryogenic vessel.

With the present invention, a simple and reliable technique for thermally disconnecting a refrigerator from a cryogenic vessel is provided. Time-to-dry and time-to-refill are extended. Cryogen losses are reduced for the same transportation time.

The present invention provides a method of thermally disconnecting a cryogenic vessel, said cryogenic vessel containing a cryogen, from a refrigerator, said refrigerator being adapted for cooling said cryogen, wherein the cryogenic vessel is connected with the refrigerator by means of an input channel and an output channel, wherein the input channel and the output channel are adapted to provide a loop system for a convection circulation of cryogen through a circulation path, comprising the step of preventing any convection circulation of cryogen loop system by stopping the circulation of cryogen, thereby thermally disconnecting the refrigerator from the cryogenic vessel.

The present invention also provides a cryostat, comprising a cryogenic vessel for containing a cryogen, a refrigerator for cooling the cryogen, and an input channel and an output channel, connecting the refrigerator with the cryogenic vessel, wherein the input channel and the output channel are adapted to provide a loop system for a convection circulation of cryogen through a circulation path, further comprising means for preventing any convection circulation of cryogen through the refrigerator by stopping the circulation of cryogen, thereby thermally disconnecting the refrigerator from the cryogenic vessel.

In an embodiment of the invention, a convection path is provided by means of two separate channels connecting the refrigerator with the cryogenic vessel. Such a loop system ensures better operational conditions for the refrigerator than counter-flow through a single connecting channel, as provided in prior art designs. The proposed arrangement is considerably more efficient than the existing design during normal operation, as it creates optimized convection circulation.

The present invention also provides a method which includes thermally disconnecting the cryogenic vessel from the refrigerator by stopping the gas circulation within the loop system.

In a preferred embodiment of the present invention, the gas circulation in the cooling loop is stopped. The convection circulation is interrupted by thermally balancing both sides of the gas circulation loop, ensuring that the gas pressure on both sides of the input and output channels are identical when the refrigerator is switched off. For this purpose, the present invention utilizes a stratification of cryogen gas, in particular of helium gas, to thermally disconnect the refrigerator from the cryogenic vessel. According to the invention, such a stratification is automatically generated within the input and output channels when the refrigerator is not operating, as it is the case during transportation. Such stratification is known to create adequate thermal resistance to thermally detach the cryogenic vessel from the refrigerator. Thereby, thermal disconnection can be reached without removing the cryogen from the refrigerator. Because two separate connecting channels are employed, thermal disconnection can be carried out in a very reliable way, in particular, if within both channels the same stratification columns of cryogen gas are created.

According to a preferred embodiment of the invention the input channel and the output channel are arranged in a way that allows the automatic creation of a stratification column when the refrigerator is not operating. For this purpose, input channel and the output channel are arranged vertically or substantially vertically. Preferably, the channels are arranged such that an angle ‘alpha’ between a horizontal plane and the longitudinal axes of the channels is between 70° and 110° (alpha=90°+/−20°). More preferably, the angle ‘alpha’ is between 80° and 100° (alpha=90°+/−10°). Even more preferably, the angle ‘alpha’ is between 85° and 95° (alpha=90°+/−5°).

According to a preferred embodiment of the invention the refrigerator is a two-stage refrigerator, wherein a first stage is thermally linked to a radiation shield of the cryogenic vessel, and a second stage provides cooling of the cryogen gas, e.g. by recondensing it into a liquid in an associated recondensing chamber housing a recondenser, and which is linked to the cryogenic vessel by both the input channel and the output channel.

The input channel preferably opens into the recondensing chamber at a position above the second stage of the refrigerator, while the output channel opens into the recondensing chamber at a position below the second stage of the refrigerator. By this means a very efficient convection loop is created and an effective cold exchange during normal operation is ensured.

As the pressure is defined by integral of gas density profile along the input and output channels, and density is defined by the temperature profile of the channels, identical gas pressure on the both sides of the loop at the recondensing chamber requires different lengths of channels. Therefore, according to a preferred embodiment of the invention, the input channel and the output channel are adapted in a way that the gas pressure at both sides of the channels (17, 18) is identical or substantially identical at the recondensing chamber.

In a preferred embodiment of the present invention the input channel is designed longer than the output channel and/or the input channel is thermally insulated, in order to create a temperature profile such that the pressure on both ends is balanced and gas circulation stops automatically, if the refrigerator is non-operative, e.g. during transportation. In other words, the input and output channels, which are connecting the both sides of the loop, are adapted in a way that allows different thermal lengths of gas in the channels, ensuring no pressure difference and no gas circulation when the refrigerator is inactive.

### BRIEF DESCRIPTION OF THE DRAWINGS

FIG. 1 schematically illustrates a cryostat in accordance with the invention.

FIG. 2 shows a detailed illustration of the refrigerator of the cryostat shown in FIG. 1, during normal operation.

FIG. 3 shows a detailed illustration of the refrigerator of the cryostat of FIG. 1, during transportation.

### DESCRIPTION OF THE PREFERRED EMBODIMENTS

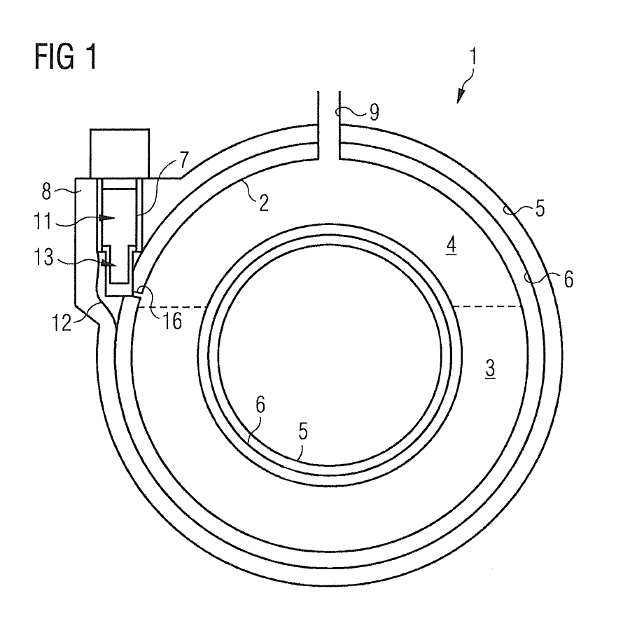

FIG. 1 shows a cryostat 1 such as may be employed for holding magnet coils for an MRI (magnetic resonance imaging) system. A cryogenic vessel 2 holds a liquid cryogen 3, e.g. liquid helium. The space 4 in the cryogenic vessel 2 above the level of the liquid cryogen 3 may be filled with evaporated cryogen. The cryogenic vessel 2 is contained in a vacuum jacket 5. One or more heat shields 6 may be provided in the vacuum space between the cryogenic vessel 2 and the vacuum jacket 5. A refrigerator 7 is mounted in a refrigerator sock located in a turret 8 provided for the purpose, towards the side of the cryostat 1. Another turret with an access neck 9 is provided at the top of the cryostat 1, allowing access to the cryogenic vessel 2 from the exterior. This is used to fill the cryogenic vessel 2, to provide access for current leads and other connections to superconductive coils housed within the cryogenic vessel 2.

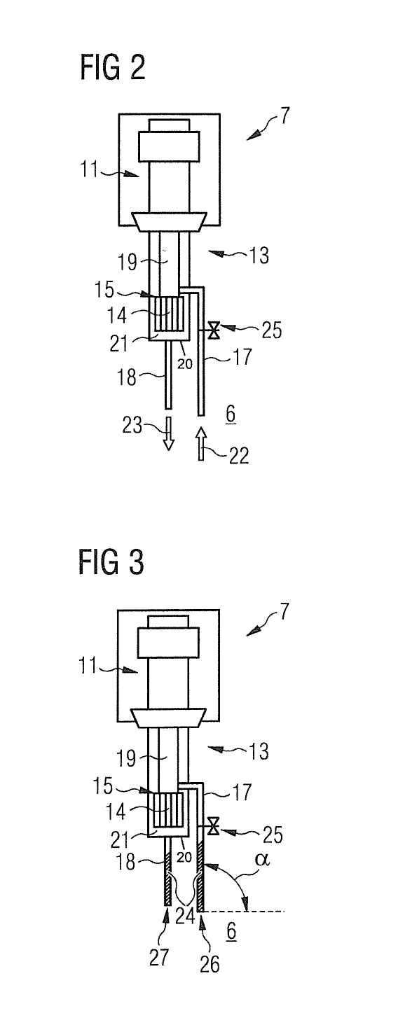

The refrigerator 7 is a two-stage refrigerator. The first cooling stage 11 is adapted for cooling the radiation shields 6 of the cryogenic vessel 2 via thermal couplings 12 to a first temperature, typically in the region of 80 to 100K, in order to provide a thermal insulation between the cryogenic vessel 2 and the surrounding vacuum vessel. The second cooling stage 13 is adapted for cooling the cryogen gas to a much lower temperature, typically in the region of 4 to 10 K, e.g. by cooling of heat transfer plates 14 of a recondenser 15, see also FIGS. 2 and 3. In a conventional cryostat design, as depicted in

FIG. 1, the refrigerator 7 is connected with the cryogenic vessel 2 by means of a single tilted tube 16. Within this tube 16 cryogen gas flows from the vessel 2 into the refrigerator 7 and at the same time liquid cryogen flows from the recondenser 15 back into the vessel 2.

According to an aspect of the invention, instead of a single connection tube 16, an input channel 17 and an output channel 18 are provided for connecting the refrigerator 7 with the cryogenic vessel 2, as seen in FIGS. 2-3. Preferably, both channels 17, 18 are thin-walled, isolated pipes or tubes. Both channels 17, 18 are designed and positioned in a way to provide a convection circulation of cryogen in form of a loop system.

During the cooling process of the magnet system, cryogen gas is created above the liquid cryogen level by boiling of the liquid cryogen. Cryogen gas passes through the input channel 17 to the volume 19 within the recondensing chamber 20, at a position above the recondenser 15. For this purpose, the input channel 17 connects the space 6 in the cryogenic vessel 2 above the level of the liquid cryogen with the volume 19 within the recondensing chamber 20 above the recondenser 15.

Cryogen gas passing the heat transfer plates 14 of the recondenser 15 recondenses into liquid cryogen. The resulting liquefied cryogen then flows by gravity through the output channel 18 back to the cryogenic vessel 2. For this purpose, the output channel 18 connects the bottom region 21 of recondensing chamber 20 volume 19 with the space 6 in the cryogenic vessel 2. In FIG. 2 the cryogen gas flow through the input channel 17 is identified by arrow 22, and the backflow of the liquid cryogen through the output channel 18 is identified by arrow 23. The illustrated design employing two separate connecting channels 17, 18 results in a larger cryogenic margin of the cryostat 1.

Furthermore, and significantly for the present invention, the channels 17, 18 are arranged vertically or substantially vertically, such that a column of stratified cryogen gas 24 is automatically created within each channel 17, 18 when the refrigerator 7 is inoperative, as illustrated in FIG. 3. In the illustrated embodiment, the angle ‘alpha’ between a horizontal plane and the longitudinal axes of the channels 17, 18 is 90°. Thus, if the refrigerator 7 is switched off, and stops cooling the recondenser 15 e.g. during transportation of the cryostat 1 to an operational site, stratification of cryogen gas automatically occurs. As a result, both channels 17, 18 contain stratified cryogen gas 24. The stratification columns 24, which are symbolized in FIG. 3 by hatching, prevent any further convection circulation of cryogen through the recondensing chamber 20, past recondenser 15, thereby thermally disconnecting the recondenser 15 from the cryogenic vessel 2.

For example, the heat flow through a column 24 of stratified helium would be less than 3 mW, given a column 24 of 10 cm height and 1 cm in diameter.

The input channel 17 and the output channel 18 are preferably adapted to thermally balance both sides of the gas circulation loop in a way that the gas pressure at both sides of the channels 17, 18 is identical at the recondensing chamber 20.

The cryostat design as described above ensures an improved cold exchange during normal operation and allows an automatic thermal detaching of the refrigerator 7 from the cryogenic vessel 2 during transportation, resulting in reduced cryogen losses.

In some embodiments, a further means to interrupt the circulation path is provided by means of an optional valve 25 which may be provided, to close the input channel 17 and/or the output channel 18. Preferably, the valve 25 is controlled in a way that the valve 25 automatically closes every time when the compressor of the refrigerator 7 stops.

Although modifications and changes may be suggested by those skilled in the art, it is the intention of the Applicant to embody within the patent warranted hereon all changes and modifications as reasonably and properly come within the scope of the Applicant's contribution to the art.

1-8. (canceled)

9. A method for thermally disconnecting a cryogenic vessel from a refrigerator, said cryogenic vessel containing a cryogen and said refrigerator being configured to cool said cryogen by cooling a recondenser within a recondensing chamber, said cryogenic vessel being connected with said recondensing chamber via an input channel and an output channel that are generally vertically oriented, said input channel and said output channel being configured to form a loop system for convection circulation of the cryogen through a circulation path that passes through the recondensing chamber, said method comprising:
preventing convection circulation of cryogen through the recondensing chamber by stopping said circulation of cryogen and thereby thermally disconnecting the refrigerator from the cryogenic vessel; and
stopping said circulation of cryogen by creating a column of stratified cryogen gas automatically within each of the input channel and the output channel when said refrigerator is not operating; and
providing said input channel with at least one structural attribute selected from the group consisting of the input channel being longer than the output channel, and thermally insulating said input channel.

10. A method as claimed in claim 9 comprising also preventing said circulation of cryogen by closing a valve that interrupts said circulation path.

11. A method as claimed in claim 10 comprising automatically closing said valve when said refrigerator is not operating.

12. A cryostat comprising:
a cryogenic vessel that contains a cryogen;
a recondensing chamber;
a recondenser situated within the recondensing chamber;
a refrigerator that cools the cryogen by cooling the recondenser within the recondensing chamber;
an input channel and an output channel that are generally vertically oriented and that connect the recondensing chamber with the cryogenic vessel;
said input channel and said output channel forming a loop system for convection circulation of said cryogen through a circulation path that passes through the recondensing chamber; and
said input channel comprising a structural attribute selected from the group consisting of the input channel being longer than the output channel, and thermal insulation of said input channel.

13. A cryostat as claimed in claim 12 wherein, when said refrigerator is not operating, a column of stratified cryogen gas is automatically produced within each of said input channel and said output channel, said column of stratified cryogen gas preventing convection circulation of the cryogen through the recondensing chamber, and thereby thermally disconnecting the refrigerator from the cryogenic vessel.

14. A cryostat as claimed in claim 12 comprising a valve operable to interrupt said circulation path.

15. A cryostat as claimed in claim 12 wherein said refrigerator is a two-stage refrigerator, and wherein said input channel connects the recondensing chamber above a second stage of said refrigerator with the cryogenic vessel, and said output channel connects the recondensing chamber below the second stage of the refrigerator with the cryogenic vessel.

16. A cryostat as claimed in claim 12 wherein said input channel and said output channel and said output channel are configured to cause a gas pressure at each side of said input channel and said output channel to be substantially equal when said refrigerator is not operating.
